(19) United States
(12) Patent Application Publication
(10) Pub. No.: US 2013/0308786 A1
(43) Pub. Date: Nov. 21, 2013

(54) EAR-WORN SPEAKER-CARRYING DEVICES

(71) Applicant: Wolfson Microelectronics Plc, Edinburgh (GB)

(72) Inventors: Alastair Sibbald, Cookham (GB); Martin Howle, Edinburgh (GB)

(73) Assignee: Wolfson Microelectronics Plc, Edinbugh (GB)

(21) Appl. No.: 13/952,035

(22) Filed: Jul. 26, 2013

Related U.S. Application Data
(63) Continuation of application No. 12/526,867, filed on Nov. 17, 2009.

(30) Foreign Application Priority Data
Feb. 16, 2007 (GB) 0702998.6

(51) Int. Cl. H04R 3/00

(52) U.S. Cl. CPC H04R 3/002
USPC 381/71.6

(57) ABSTRACT

An ear-worn speaker carrying device (“ESD”) incorporating active ambient noise reduction circuitry provided with a seal intended to contact or surround the ear of a user. The seal is intended to present a substantial impedance to inward or outward transmission of sound to or from the ear. At least one acoustic channel of predetermined dimensions bypasses the seal, providing an acoustic leakage path of known characteristics, thereby permitting predetermined levels of sound to enter and exit by way of the channel, such that minor variations in leakage are rendered relatively unimportant. In a preferred embodiment, the device further includes an acoustic conduit connected to vent the speaker's rear surface to the external ambient, and respective exit apertures for the acoustic channel and the acoustic conduit are relatively located so that sounds exiting from them tend to cancel each other, reducing sound emissions from the device.

The present invention relates to earphone and headphone devices, collectively referred to herein as ear-worn speaker-carrying devices, or briefly ESDs, and provides an acoustical structure for such devices that is well-suited to usage on the move, i.e. in conjunction with portable electronic appliances such as personal music players and cellular phones. The invention exhibits additional merit in connection with ESDs incorporating active ambient noise-reduction.

Conventional ESDs generally comprise one of two general types, namely, the so-called “open-back” and “closed-back” devices; which respectively exhibit particular advantages and disadvantages.

ESDs of the open-back type are characterised by the use of a speaker mounted for substantially unrestricted venting from both its front (i.e. ear-facing) and rear emission surfaces, thereby to preserve, as far as practicable, the designed frequency performance of the speaker. Such devices tend to be usefully thin and light and, because they typically use foamed pads of acoustically transmissive material against the user's ear, they allow the user to hear ambient sounds, which can be beneficial in some respects. However, a corollary to this latter advantage is that, at least in some frequency bands, open-backed devices provide substantially no passive attenuation, so that ambient sound can intrude excessively. Furthermore, such devices tend to exhibit excessive sound emission, primarily from the rear vents.

In ESDs of the closed-back type, on the other hand, the speaker is substantially enclosed to the rear, thus reducing significantly the direct outward emission of sound. Moreover, a doughnut-like ear pad is used to make an acoustic seal to the user's ear; thereby to impede both incoming (ambient) and outgoing noise. However, whilst this construction provides a significant degree of passive ambient noise reduction, at least in some frequency bands, and reduces unwanted external sound emissions, it places considerable acoustic constraints upon the speaker and significantly impairs its performance. A further disadvantage of such devices is that, when the user speaks whilst wearing them, the user's voice tends to be self-heard in a distorted manner from the substantially sealed volume between the ear and the doughnut-like ear pad.

Thus difficulties arise in providing ESDs which exhibit one or more of the foregoing desirable characteristics of either type without introducing attendant disadvantages, and it is an object of this invention to reduce or eliminate such difficulties.

According to the invention there is provided an ear-worn speaker carrying device (briefly “ESD”) comprising ear-contacting seal means providing substantial impedance to inward or outward transmission of sound to or from the ear, and at least one acoustic channel located and configured to bypass said seal means; said channel providing a sound leakage path of predetermined dimensions. By this means, predetermined levels of sound can enter and exit by way of the channel, and minor variations in leakage, dependent, for example, upon precise mounting positions of the seal means to the ear as used from time to time, are rendered relatively unimportant.

Preferably, the rear surface of the ESD's speaker is vented to the external ambient by way of an acoustic conduit, whereby a desired acoustic performance of the speaker is achieved.

It is particularly preferred that respective exit apertures for the said acoustic channel and the said acoustic conduit are located sufficiently proximate one another for the respective sounds exiting therefrom to undergo substantial mutual acoustic wave cancellation, thereby to reduce external sound emission whilst providing adequate venting to permit good speaker performance.

In some preferred embodiments, at least one dimension of the acoustic conduit increases along its length, towards the exit aperture thereof. Where such increase is employed, it preferably comprises a smooth, flaring increase of rectilinear or curvilinear form, although increases comprising one or more step-changes can be employed if desired.

The acoustic conduit may have associated therewith a resonant cavity such as a Helmholtz resonator or a quarter-wave resonator channel configuration, in order to reduce one or more undesired frequency characteristics of the conduit.

In preferred embodiments, the aforementioned seal means is preferably bypassed by a plurality of acoustic channels. Typically, the seal means has substantially circular geometry, and in such circumstances the channels preferably comprise a plurality of radial channels and their centres may be regularly distributed in angle. However, some channels may be larger than others, depending upon their intended orientation relative to the ear.

In devices according to some preferred aspects of the invention, the acoustic channel and/or the acoustic conduit may be provided with acoustic damping means such as an insert of foamed material.

An ESD of any of the foregoing kinds may preferably be provided with active noise-reduction means, and any such active noise-reduction means provided is preferably of the feed-forward kind, and may incorporate an array of ambient noise-sensing microphones.

It will thus be appreciated that devices in accordance with the invention exhibit the respective desirable properties of both open-type ESDs and closed-type ESDs, without exhibiting the respective undesirable properties of either. Preferred embodiments of the invention provide lightweight, supra-aural, pad-on-ear type headphones, or earphones in the so-called “ear-bud” format for in-ear application.

In order that the invention may be clearly understood and readily carried into effect, embodiments thereof will now be described, by way of example only, with reference to the accompanying drawings, of which:

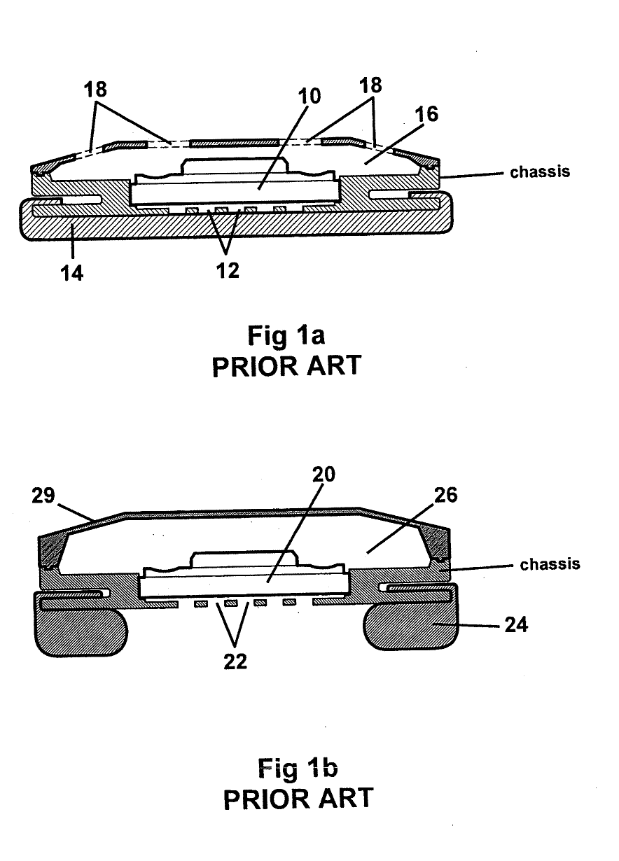

FIGS. 1a and 1b show, in cross-section, typical prior art ESDs of open-back and closed-back design respectively;

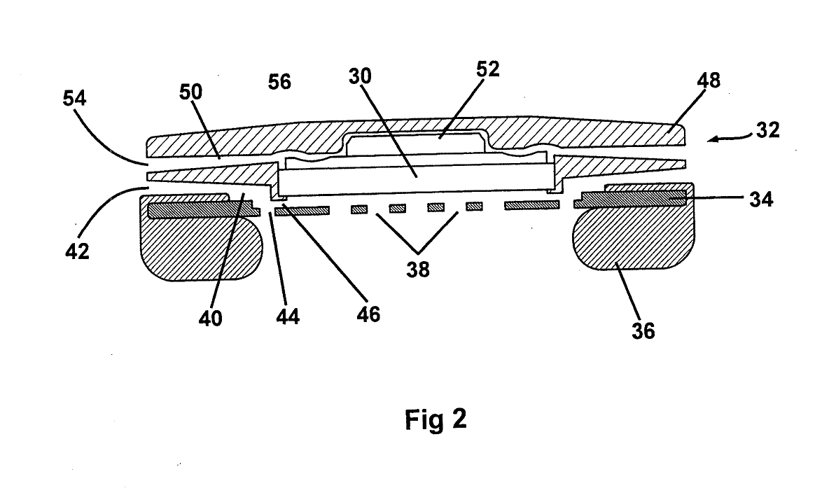

FIG. 2 shows, in cross-sectional view, an ESD in accordance with a first embodiment of the invention;

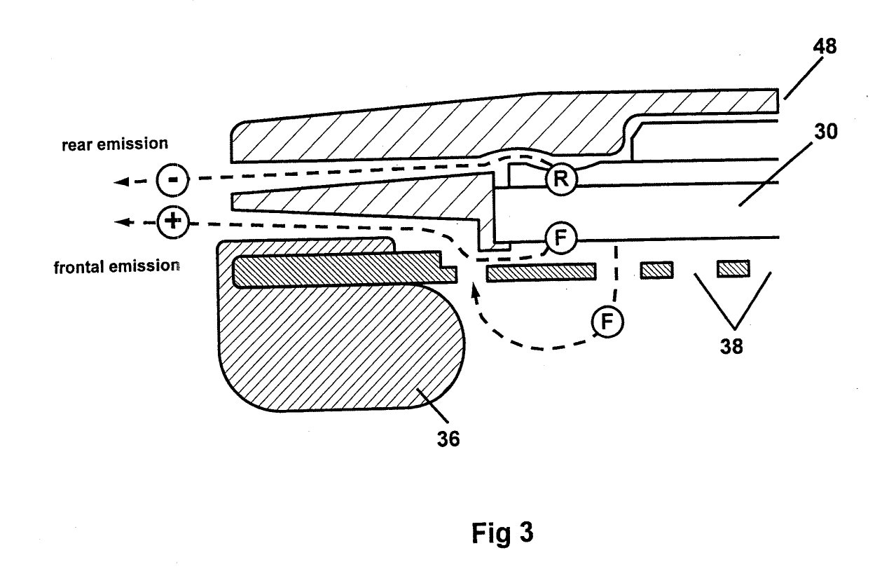

FIG. 3 shows a detail of a portion of the first embodiment of the invention;

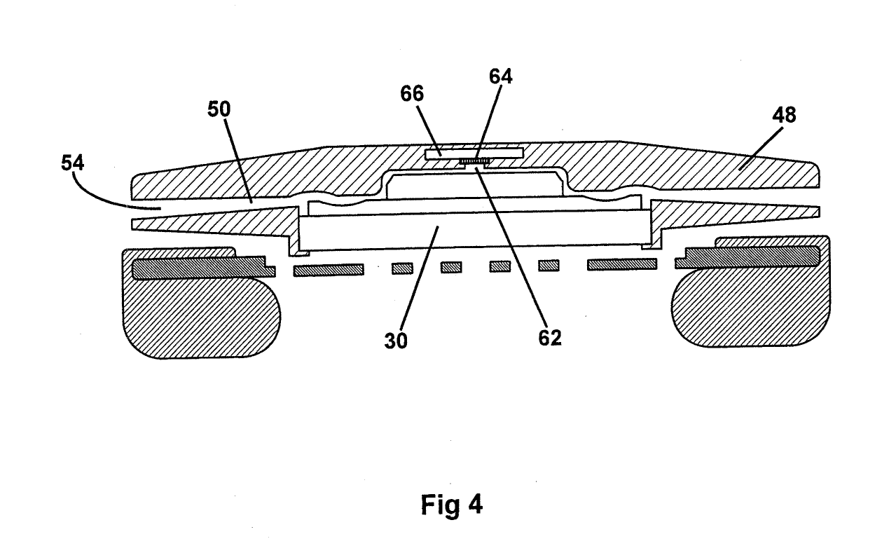

FIG. 4 shows, in similar view to FIG. 2, a modification to the first embodiment of the invention;

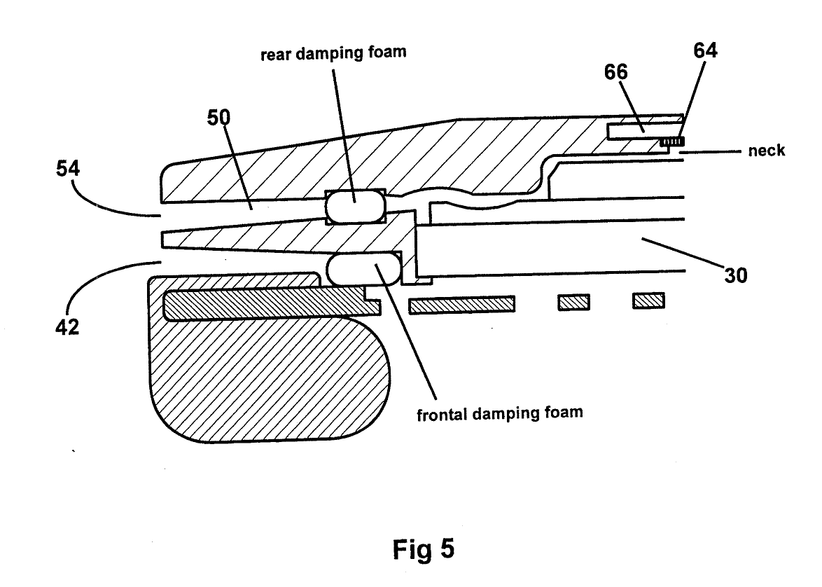

FIG. 5 shows, in similar view to FIG. 3, detail of a further modification to the first embodiment of the invention;

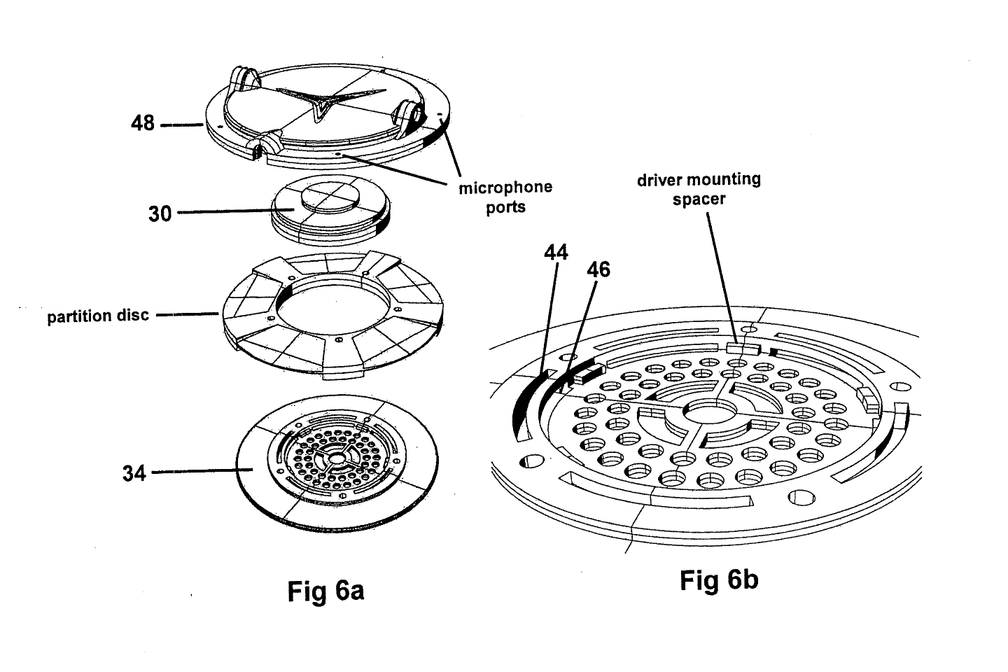

FIGS. 6a and 6b show, respectively, an exploded diagram of certain components of a practical configuration of the first embodiment of the invention and an enlarged perspective view of one of said components;

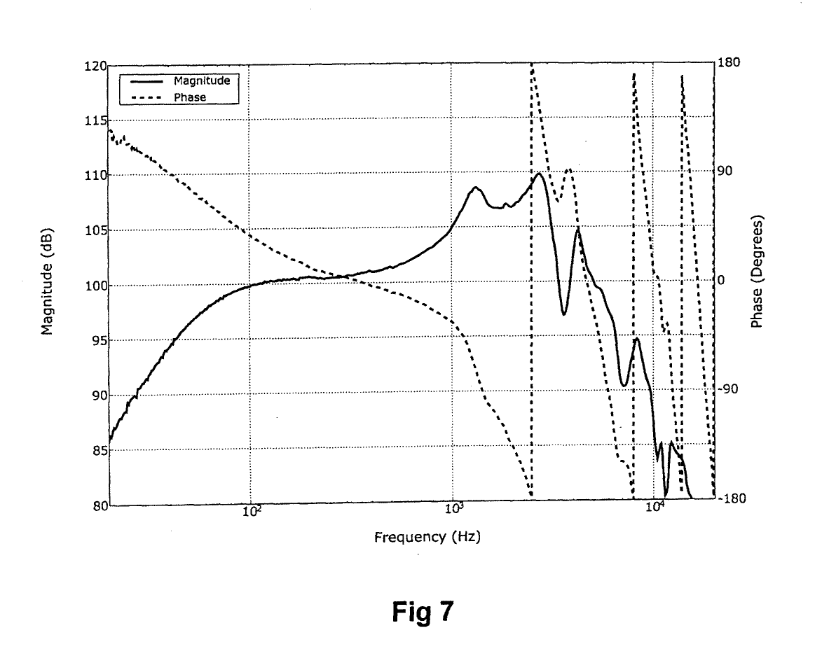

FIG. 7 comprises graphs showing typical variations of amplitude and phase with frequency in the speaker-to-ear response of the first embodiment;

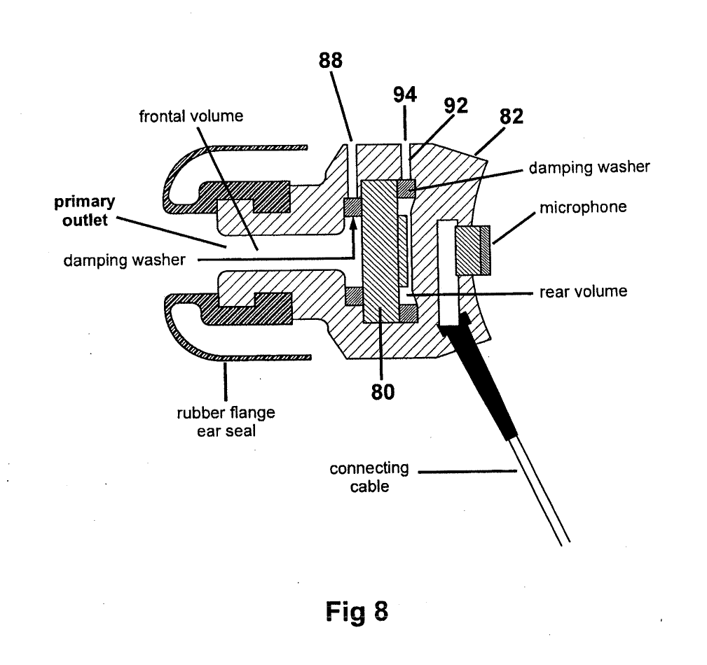

FIG. 8 shows, in cross-sectional view, an ESD in accordance with a second embodiment of the invention;

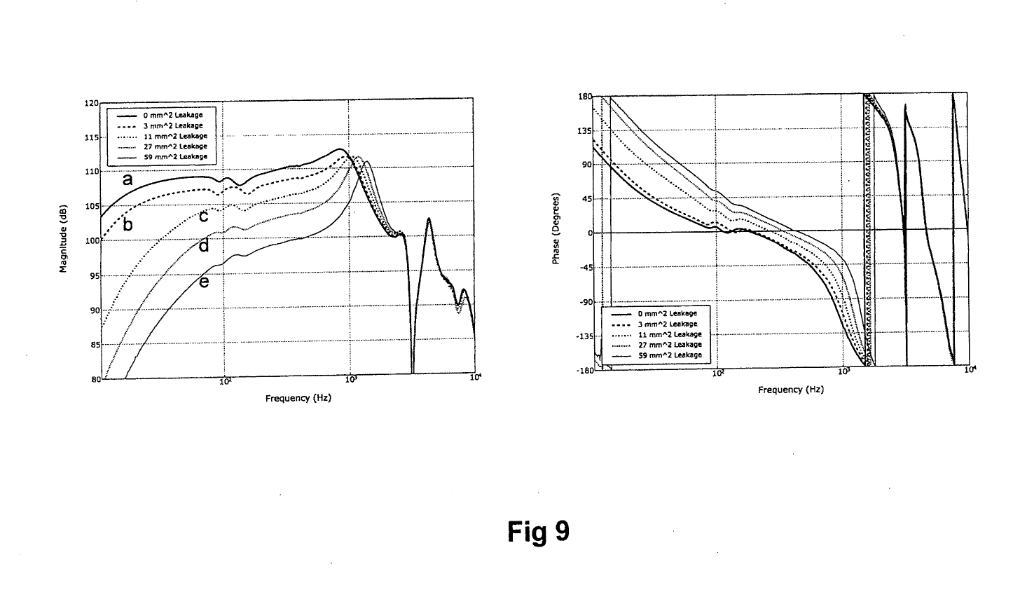

FIGS. 9 to 11 show respective graphs indicative of performance variations of ESDs of the kind shown in FIGS. 1a and 1b, modified by the provision of various vents and conduits;

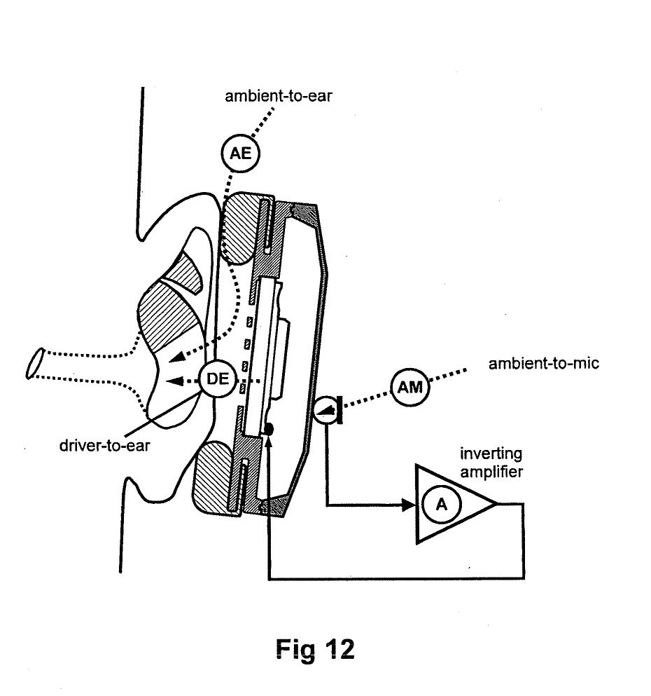

FIG. 12 shows an ESD in position on an ear and illustrates certain primary transfer functions useful in understanding feed-forward noise-reduction; and

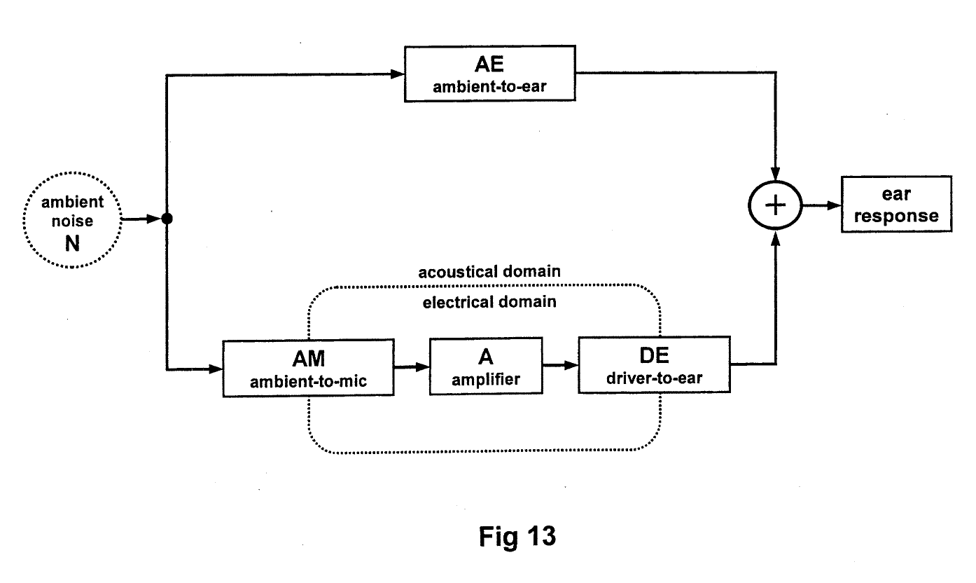

FIG. 13 shows in schematic, block-diagrammatic form, a connectivity relationship between the transfer functions illustrated in FIG. 12.

In general terms, with conventional ESDs, the philosophy behind open-type ESD structures is to maintain, as far as possible, the free-field frequency response of the ESD's loudspeaker (which has been optimised by the manufacturer to be as flat and wide-ranging as possible) by ensuring that the frontal and rearward acoustic loading of the speaker is unimpeded by resonant cavities or closed volumes, which would otherwise curtail and modify the perceived frequency response. In order to achieve this, as shown in FIG. 1a, the front (ear-facing side) of the loudspeaker 10 is mounted behind a thin, protective perforated plate 12, which is covered with an acoustically transparent, foam-rubber ear-pad 14 that lies flat against the outer-ear (not shown) of a wearer. Consequently, there is a relatively large acoustical leakage through the foam in a lateral direction between the phone-to-ear cavity and the external ambient, and so the speaker 10 does not drive solely into an enclosed volume of air.

Similarly, the rear volume 16 behind the speaker 10 is vented directly to the external ambient via one or more apertures 18 having a large, overall surface area. The benefit of the speaker 10 being relatively unenclosed is that its intrinsic response is more or less unimpaired, which enables a flat, smooth frequency response to be achieved, having a good high frequency response. Another benefit is that the lateral acoustic leakage through the foam ear-pad 14 allows the wearer to hear the external world, to a large extent, and there is no feeling of being “enclosed” or isolated, which some find uncomfortable. Finally, the open structure is intrinsically thin and lightweight because it does not require a large rear volume cavity.

The main disadvantage of the open-type structure is that the outward acoustical emissions from the rear cavity 16 can be excessively loud, and, when in use travelling, this can be annoying to other people. A second disadvantage for some wearers is that they prefer to have some degree of passive attenuation of external noise, which the relatively large frontal leak through the foam ear-pad 14 does not afford.

On the other hand, the philosophy behind the closed-back structure is to provide some degree of isolation between the listener and the external ambient, both to: (a) reduce the ambient noise level perceived by the wearer, and (b) minimise the outward emission from the headphone itself. Accordingly, and with reference to FIG. 1b, instead of a foam ear-pad, such as 14 (FIG. 1a), which is acoustically transparent and allows much external noise to reach the ear, it is common practice, to employ “doughnut” style ear-pads 24, typically in the form of leatherette-skinned, toroidal-shaped foam-rubber rings, arranged so as to form a cushion between the ear and the headphone around the periphery. The foam-supported leatherette skinned material, being substantially air-tight, is thus largely acoustically opaque, and is intended to form a seal with the outer ear and reduce the leakage between the phone-to-ear cavity and the external ambient, thus passively reducing noise ingress. Generally, this is effective for higher frequencies, above 3 kHz, although it is not effective below 1 kHz.

However, when the phone-to-ear cavity is largely sealed from the external ambient by a doughnut ear-pad such as 24, it represents almost a purely compliant acoustic couple between the speaker and the ear, with consequent gross effects on the perceived frequency response, and also on the phase characteristics of the speaker-to-ear transfer function. Generally, although the low-frequency response (in the range up to around 1 kHz) can increase by as much as 6 to 10 dB by the use of doughnut seals 24 (in lieu of foam pads 14), there is often an associated reduction in response above this frequency range. The overall perceived effect is that the frequency response becomes curtailed above about 4 kHz, which is not suitable for high-fidelity reproduction.

Another undesirable effect of largely sealing the outer ear cavity is that, when the user talks, voice conduction via the mastoid bone into the middle ear structure introduces a large, low-frequency dominated voice signal into the ear canal. Ordinarily, much of this energy escapes out of the ear canal, and, when speaking, an individual hears his own voice naturally. However, when the canal and outer-ear are effectively occluded by the pad-to-ear volume, the energy does not escape, and the result is that the user hears his own voice, unnaturally loud and low-frequency enhanced, and this is unpleasant. This “sealed ear” phenomenon also interferes with spoken communications when wearing the headphones.

In terms of minimising the outward emission, it is common practice to employ a “closed” (that is, non-vented) rear cavity 26. However, this represents a significant acoustical load to the rear of the loudspeaker 20 in the form of a pure compliance. This reactive impedance has very significant effects on the speaker-to-ear response, thus influencing the frequency-dependent amplitude and phase characteristics. These effects can be lessened somewhat by increasing the size of the enclosed rear volume 26, such that its compliance is greater. Nevertheless, the acoustical effects of employing an enclosed rear volume remain significant, to the extent that effective feed-forward noise-cancellation becomes impossible to achieve with this format.

In principle, the rear enclosure 29 of the closed-back system would appear to occlude outward emission from the rear of the loudspeaker 20 to a nearby listener. However, this is not entirely true because, even though the direct airborne path is occluded, sound transmission can still occur through the headphone casing 29, especially at lower frequencies. Furthermore, if a small vent is introduced into the closed rear volume 26 to increase its effective compliance (as is done by some manufacturers), the total outward emission is increased.

The present invention provides an ESD having the benefits of both types of system, in that it provides the substantially flat frequency response of an open-back system, but exhibits the reduced outward emission of a closed-back system. It is especially valuable that ESDs in accordance with embodiments of the invention also exhibit amplitude and phase characteristics that are well-suited to feed-forward ambient noise-cancellation, and they can moreover be fabricated in compact and lightweight form.

For mobility whilst wearing ESDs, it is important that the devices are lightweight and not cumbersome in use, and it is beneficial if the wearer can “hear through” the ESD when it is switched off whilst still being worn. This allows some degree of spatial hearing to be retained, and is therefore a valuable safety feature for wearers when they are using public transport, for example, or negotiating traffic.

It is possible to categorize the various different types of ESD according to their size, as follows.
1. In-Ear
In-ear type earphones, either fitted with thin, rubber acoustical sealing flange(s), (termed “ear-bud”), or alternatively, lower-cost devices having a relatively loose fit into the ear.
2. Supra-Aural
“Pad-on-ear” type headphones that lie flat on, and against, the surface of the pinna (outer ear flap), either having a foam disc surface or, alternatively, fitted with a “doughnut” ear-pad intended to form a peripheral acoustic seal around the rim in order to achieve some acoustic attenuation of the incoming ambient noise that permeates into the ear from the outside world.
3. Circumaural
Here, a larger housing is used, slightly bigger than the pinna itself, such that when located in position against the side of the head, a large, cushion-type rubber seal around the rim of the housing forms a substantial acoustic seal between the ambient and the inner cavity now existing between the ear and the inner surface of the earphone shell.

For applications in which the wearer requires mobility, the circumaural types are somewhat impractical; it is the ear-bud and supra-aural types that are currently most popular, and thus the invention will be described in relation to these latter types and, in particular, the supra-aural type.

FIG. 2 depicts a cross sectional view of an embodiment of the invention in a supra-aural headphone format, and FIG. 3 shows further detail of the same. Referring to FIG. 2, the loudspeaker 30 is mounted in a partition disc assembly 32 that is mounted on to a chassis disc 34. The chassis 32 provides support for a doughnut-type ear-pad 36 around its peripheral rim, and there is an array of apertures 38 present in the chassis, forming an acoustically transparent protective grille in front of the diaphragm of the loudspeaker 30. A controlled and defined leakage channel, comprising one or more frontal conduits such as 40, radially disposed around the disc assembly 32, is used to join the frontal volume (that between the ear and the loudspeaker 30) with a front emission port 42 at the outer rim of the ESD. The inner end of the frontal conduit 40 couples directly into the frontal volume via a slot 44 formed in a peripheral region of the grille comprising the apertures 38. The conduit 40 also couples laterally, via a slot 46, into a space between the diaphragm of the speaker 30 and the front grille in order to provide a sufficiently large value of surface area for the inbuilt frontal leakage at the inner end.

A third disc is used for the rear cover 48, mating with the conduit partition disc 32, thus forming an upper (outer) surface for one or more rear conduits, such as 50 and also creating a rear cavity 52 of small volume. The rear conduit 50, like the front conduit 40, also comprises one or more radially disposed elements formed in the partition disc assembly 32, and is used to acoustically join the rear volume 52 with a rear emission port 54 on the outer rim. The inner end 56 of the rear conduit 52 couples directly into the minimal rear volume 52 behind the diaphragm of the speaker 30. Preferably, the cross-sectional area of the rear conduit 50 gradually increases from a small value at the innermost end 56, to a larger aperture at the outermost end at the rear emission port 54, in order to minimise the effects of any conduit resonance.

The outward leakage paths of both conduits are shown in FIG. 3, together with their mutually adjacent outlet ports 42 and 54 which permits destructive wave-cancellation to occur between the respective outbound emissions. In this respect, it will be appreciated that sounds from the oppositely-directed emission surfaces of the speaker 30 are oppositely phased as a matter of course, and that by locating the respective outlet ports sufficiently close together, the required destructive wave-cancellation can be promoted.

Residual conduit resonance can be compensated for by the inclusion of one or more suitable Helmholtz resonators, for example as described in our WO 2005/051037. In the embodiment of FIGS. 2 and 3, these can be built into the partition disc segments lying between the individual conduits themselves, on a one-per-conduit arrangement using an integrated planar network as described in our UK patent application GB 0510438.5. Alternatively, a single, conventional-type Helmholtz resonator 60 can be built into the rear cover plate 48, in the form of a volume element in the plate, acoustically coupled via a suitable aperture or tube 62 to the central portion of the rear volume, above the magnet of loudspeaker 30, as depicted in FIG. 4. If required, suitable damping can be incorporated by including an acoustic mesh resistance 64 in series with the aperture or tube 62, as shown.

An exploded, isometric diagram of the above embodiment in its simplest form, as shown in FIG. 2, is depicted in FIG. 6a, comprising (from the lowermost unit upwards) the chassis disc, partition disc, loudspeaker driver and rear cover disc. Details of the arrangements for slots 44 and 46 (FIG. 2) are also shown in FIG. 6b.

The speaker-to-ear response of this embodiment of the invention, featuring the Helmholtz cavity conduit compensation means of FIG. 4, is shown in FIG. 7. Bearing in mind that this response is measured on an artificial ear system, which accounts in part for the broad resonance between 1 and 2 kHz, the amplitude response is relatively smooth, and extends to below 100 Hz. The phase response, too, is smooth, and it is free from artefacts up to about 3 kHz. Both of these parameters are comparable with those similarly obtained for a conventional open-backed ESD, with large frontal leakage, and are well-suited to ambient noise-cancellation.

The incorporation of active ambient noise-reduction into an ESD of the kind just described is straightforward, requiring the addition of one or more external microphones and suitable electronic circuitry. Preferably a feed-forward noise-reduction system is employed, and a particularly preferred manner of implementing such a system, utilising a peripheral array of several ambient noise-sensing microphones, is described in our co-pending UK patent application No. GB 0601536.6. It is desirable, in such an embodiment, that the ambient noise-sensing microphones are positioned as far as possible from the outlet port pairs. This is achieved, in this example, by placing them in the inter-conduit spacing areas, as shown in FIG. 6a, where locations such as 70 for five 3 mm-diameter electret microphones are positioned in the rear cover disc in between the five outlet port regions.

FIG. 8 (in which, for clarity, the wiring detail is not shown), depicts a cross sectional view of another embodiment of the invention, configured as an ear-bud, and including an optional external microphone to enable feed-forward ambient noise cancellation. Although this embodiment of the invention provides a substantially smaller ESD than that provided by the previously described embodiment, the principle remains the same, namely:
1. the provision of a reasonably good frontal seal between an electroacoustic transducer and the ear;
2. the introduction of a fixed, pre-determined acoustical leakage between the frontal volume and the external ambient, in order to create a desired driver-to-ear response;
3. the provision of a rear conduit to couple the rear volume to the external ambient; and
4. arranging the outer ports of the frontal leakage and rear conduits to be mutually adjacent in order to enable destructive interference of the outward emissions via the frontal leakage and rear conduit.

Referring to FIG. 8, the microspeaker 80 is mounted in a suitable tubular housing 82, fitted with conventional thin rubber flanges 84 for forming an acoustic seal against the inner surface of the outer part of the ear canal, as is common practice. A frontal leakage channel 86 is coupled to a front outlet port 88, sited on an upper portion of the housing 82, and a rear volume 90, to the rear of the speaker 80, is acoustically coupled to a conduit 92 leading to a rear outlet port 94, sited adjacent to the front outlet port 88. Also provided in this particular example, though optional, are damping washers 96 and 98, disposed around the periphery of the frontal and rear volume regions respectively, so as to provide serial acoustic damping elements for the frontal leakage path and rear conduit means. The damping washers conveniently comprise annular felt or foam rubber elements, but alternative damping means may be used if preferred, such as a closely woven metal (“acoustic”) mesh over the respective leakage opening, or a cotton plug situated in the respective leakage path.

Again, as mentioned previously, the critical factor for achieving successful ambient noise-cancellation is to select the particular value of frontal leakage which enables a reasonable match between the ambient-to-ear and speaker-to-ear transfer functions, especially (for ear-buds) at low frequencies, up to 500 Hz. The frontal leakage impedance in the ear-bud is determined by the length and cross-sectional area of the leakage tube or conduit, and its associated damping.

The nature of the rubber flange ear-seals is such that they provide good high frequency attenuation of incoming noise, generally above 1 kHz. Consequently, for ear-buds, active noise-cancellation is not required much beyond this frequency.

In general, therefore, it will be appreciated that the invention provides ESDs, especially (but not limited to) supra-aural devices and ear-buds, in which the frontal section is sealed to the ear using a compliant, acoustically opaque means (e.g. doughnut or skinned foam), and where according to various features of the invention, which are preferably, though not necessarily, used in combination:

(1) a significant and well-defined acoustical leakage path is provided between the frontal volume and the ambient,

(2) the rear section/volume is arranged to have significant leakage to ambient, and

(3) the leakage paths are vented to the ambient sufficiently adjacent one another that the emitted acoustic radiation from the frontal volume and the emitted acoustic radiation from the rearward volume combine via destructive interference, thus reducing the outbound emissions.

Embodiments of the present invention provide ESDs well-suited to use with appliances intended for employment on the move, such as personal music players and cellular phones, and some such embodiments additionally exhibit electro-acoustic properties that are especially valuable for use in association with feed-forward ambient noise-reducing systems.

When used in association with active ambient noise-reduction, embodiments of the invention exhibit additional benefits in terms of tolerance to variations in headphone placement, both from use-to-use and from person to person, and enable the use of doughnut-style ear-pads, which are more resilient than foam ear-pads.

Embodiments of the invention, moreover, provide novel ESD architectures, based upon conformance with one or more, and preferably all three, of the following features.
1. A frontal volume assembly, provided with ear-sealing means and a predetermined acoustical leakage pathway bypassing the seal.
2. A small rear volume structure which is vented, preferably via one or more flared conduits.
3. Leakage-venting arrangements for the frontal volume assembly and the rear volume structure, arranged so as to neutralise outward acoustic emissions.

The frontal volume feature of the present invention provides a sealed ear-pad system (such as doughnuts or skinned foam) in conjunction with an inbuilt, predetermined acoustic leakage pathway between the ambient and the pad-to-ear cavity, bypassing the seal such that the inbuilt leakage is (a) sufficiently small to reduce or eliminate the above-mentioned problems associated with pad-on-ear systems of the kind shown in FIG. 1a, but (b) sufficiently large to keep any disturbance of the speaker-to-ear phase (and amplitude) response within tolerable limits, and also to make the day-to-day leakage variations around the ear-pad seal small in relation to the inbuilt leakage value, and therefore negligible.

In contrast to the foam pad-on-ear system, which possesses relatively large frontal leakage, and to the alternative doughnut-type arrangements with their relatively small frontal leakages, embodiments of the present invention provide arrangements incorporating a fixed, predetermined, integral frontal leakage bypassing a doughnut-type seal or its equivalent. By choosing a suitable value of fixed frontal acoustical leakage, it is possible to balance the requirements of (a) maintaining adequate matching of the phase and amplitude responses of ambient noise-to-ear and speaker-to-ear transfer functions, whilst (b) minimising the required drive level to the speaker, thereby reducing any tendency for acoustic feedback and alleviating relatively high current consumptions associated with compensating for the large amounts of ambient noise entering past foamed pad structures such as that of FIG. 1a.

By choosing a value of fixed frontal leakage that is significantly greater than that of the intrinsic parasitic leakage which occurs underneath (and through) the doughnut pads, the uncontrollable and unpredictable day-to-day and person-to-person variations in the parasitic leakage no longer have such a sensitive influence on the speaker-to-ear transfer function, because they are now disposed in parallel with the much greater, constant acoustical leakage that dominates the overall leakage impedance.

Some embodiments of the invention incorporate a fixed, predetermined frontal leakage in the form of one or more acoustical conduits travelling between the frontal volume, encompassed by the doughnuts, and the ambient. In the absence of damping means, this leakage represents an acoustical mass (M_{A}), characterised by the length (L) and cross-sectional area (S) of the conduit:

$${M}_{A} = \frac{{ρ}_{0} L}{S} kg . {m}^{- 4} \qquad ( 1 )$$

where ρ₀ represents ambient air density (˜1.18 kg·m⁻³).

A preferred value of fixed acoustical leakage for a particular ESD chassis (that is, combination of loudspeaker, doughnuts and enclosure) can be identified by making speaker-to-ear measurements for a range of differing frontal leakage values, and selecting the minimum leakage value which allows reasonable matching of the ambient-to-ear and speaker-to-ear phase responses.

An example of this is depicted in FIG. 9, which shows a family of speaker-to-ear responses for a range of different leakage values, measured from an open-back headphone bearing doughnut-type front seals, and featuring a 38 mm high-compliance loudspeaker. The amplitude response plots are shown on the left, and the phase plots are shown on the right.

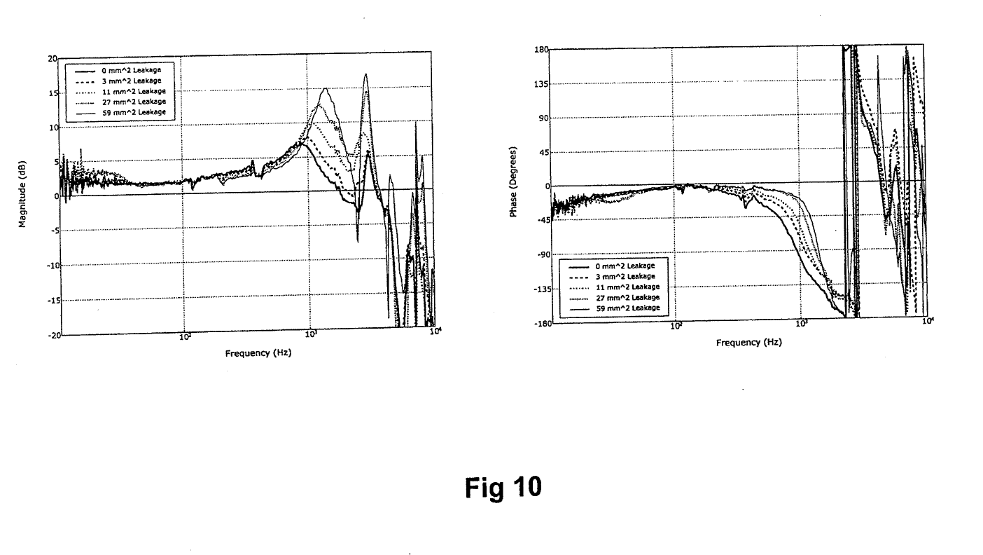

FIG. 10 shows the associated ambient-to-ear responses, measured simultaneously. The measurements were made using an artificial ear simulator system featuring (a) a flat outer surface plate in order to provide a good and reproducible seal to the doughnut pads, bearing (b) a simplified concha feature in the form of a 22 mm diameter, 10 mm deep cylindrical cavity, in conjunction with (c) a 7.5 mm diameter, 22 mm long canal-simulator element, with foam damping, terminated by a reference microphone (B&K type 4190). In addition, several 10 mm long conduits with differing, binary-weighted cross-sectional areas in the range 2 mm² to 32 mm² were incorporated between the concha cavity element and the ambient, such that they could be individually selectively occluded so as to provide a wide range of fixed, accurate leakage values, up to 62 mm². (This represents acoustical mass values between 190 and 5900 MKS units.) The plots of FIGS. 9 and 10 represent five data sets, relating to frontal acoustic leakages of 0, 3, 11, 27 and 59 mm², (where the leakage length value is 10 mm).

Referring to FIG. 9, the family of curves for the speaker-to-ear amplitude responses show that, as the frontal leakage is progressively increased, the low frequency response, below 500 Hz, falls incrementally, and the resonant peak at ˜850 Hz increases uniformly to 1400 Hz. Referring to FIG. 10, a similar situation obtains for the ambient-to-ear responses, with both the magnitude and frequency of the resonant peak associated with the frontal volume increasing in step with increased frontal leakage values. However, for small leakage values, there are spurious resonances in both amplitude and phase, such as that at 400 Hz, which interfere with noise cancellation efficiency.

Inspection of the phase data of FIGS. 9 and 10 also shows similarities in change owing to the progressive increases in frontal leakage. Here, however, the increased leakage values enable a better match between speaker-to-ear and ambient-to-ear responses. For example, at 1 kHz, the no-leakage phase values of the two characteristics are −126° and −99° respectively (a 27° difference), whereas with 59 mm² leakage area, the values are −37° and −21° respectively, (16° difference). Bearing in mind that effective noise reduction requires phase-matching criterion of <20°, the 59 mm² (10 mm length) frontal leakage value satisfies this requirement, whereas the non-leaky system does not.

In summary, the presence of a significant frontal leakage reduces spurious resonant artefacts, and enables better, and satisfactory, phase-alignment between the speaker-to-ear and ambient-to-ear transfer functions.

Another important benefit associated with a significant frontal acoustic leakage is that the total overall frontal leakage, including that underneath the doughnut ear-pad, remains a relatively constant value, because the inbuilt leakage is much greater than the small and variable sub-doughnut leakage, and therefore it is dominant. Consequently, the noise-cancellation signal level requires no or little adjustment; one fixed level is suitable.

An additional feature of embodiments of the invention is that the properties of the fixed, inbuilt frontal leakage can be modified advantageously by the inclusion of suitable foam rubber elements into the conduit so as to provide high-frequency attenuation, as shown in FIG. 5. By a suitable choice of foam properties, it is possible to reduce the ingress of ambient noise above 4 kHz without detrimental effect on the speaker-to-ear response at lower frequencies. Similarly, attenuating foam inserts can be inserted into the rear conduit means in order to reduce high-frequency emission above the range where mutual cancellation is possible owing to differences in phase or amplitude or both of these.

It has been established by the inventors that a high degree of precision in defining the frontal leakage is unnecessary. As described hereinbefore, an objective in fabricating any particular ESD in accordance with the invention is to balance various parameters affecting the performance of the ESD. Thus differing solutions may be adopted in order to treat certain parameters differently from others, depending upon the primary intended purpose of a given ESD. Accordingly, and subject to the constraints and requirements specified hereinbefore, differing amounts of leakage may be employed without departing from the scope of the invention.

In the particular case of ESDs in the form of ear-buds, there is special advantage to be gained by arranging the impedance of the frontal acoustic leakage path to achieve a relatively flat (i.e. flat within a range of about 4 dB) frequency-dependent speaker-to-ear (i.e. driver-to-ear (DE)) amplitude response in the range from about 80 Hz to about 800 Hz, since the inventors have found that the ambient-to-ear (AE) amplitude response of ear-buds tends to be relatively flat over part at least of this region, and it has been found beneficial to match the DE response at least reasonably closely to the AE response.

As regards the rear volume feature, the driver-to-ear characteristics of a fully open rear volume system (FIG. 1a) are ideal for noise reduction, but there is considerable unwanted outward emission. A closed rear volume (FIG. 1b), on the other hand, reduces the outward emission but unfortunately interacts with the speaker-to-ear response, though not with the ambient-to-ear response. This, therefore, mismatches the ambient noise signal and its synthesised cancellation counterpart, making it difficult, or even impossible, to achieve a useful degree of noise-reduction. Even a compromise between the two—the provision of very large area rear venting and the use of a large rear volume—is not enough to avoid this phenomenon having detrimental effects, especially on the speaker-to-ear phase response.

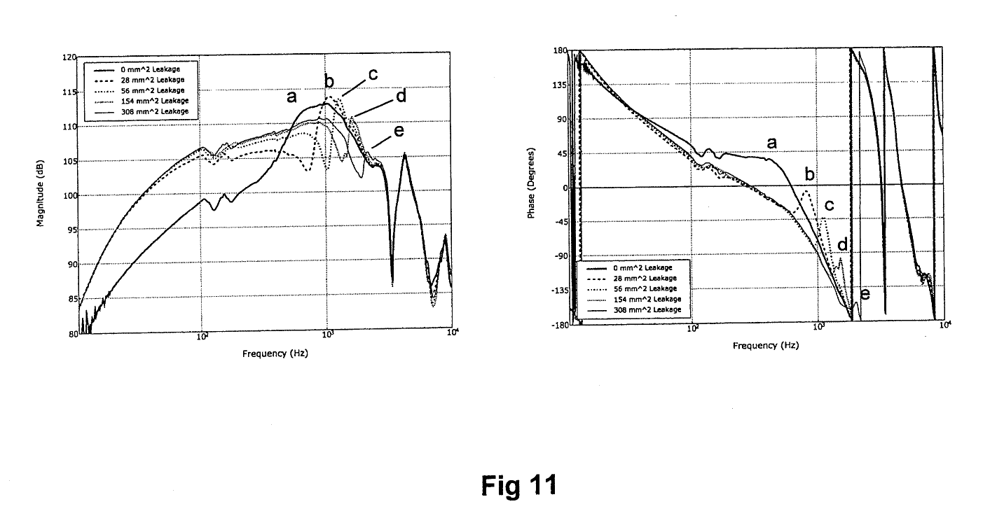

An example of this is depicted in FIG. 11, which shows a family of speaker-to-ear responses (measured as described above, and with a fixed, frontal leakage value set to a typical acoustic mass value of 421 MKS units) for a range of different rear vent leakage areas, measured from a 22.4 cm³ volume closed-back headphone bearing doughnut-type front seals, and featuring a 38 mm high-compliance loudspeaker. The plots of FIG. 11 represent five data sets, labelled “a” through to “e”, relating respectively to rear vent acoustic leakages of 0, 28, 56, 154 and 308 mm², (where the leakage length value, through the thin outer shell, is 1 mm).

Referring to the amplitude response plot shown on the left of FIG. 11, it is clear that the fully-sealed rear volume (“a”) grossly reduces the effective compliance of the driver, causing a greatly reduced low-frequency response compared to a vented rear volume (plots “b” through “e”), and also a large, broad resonant peak between 500 Hz and 2 kHz. The phase characteristics of the fully-sealed rear volume, too (plot “a” in FIG. 11, right), are grossly different from those of a vented system. More importantly, both the amplitude and phase properties of the speaker-to-ear responses are grossly different from the ambient-to-ear responses (FIG. 10), making the proximity of response matching required for useful ambient noise-reduction virtually unachievable.

Even when a leakage vent is introduced into the rear volume, the situation does not improve until the leakage is very large. For example, the results of introducing a 28 mm² leakage (1 mm in length) into the rear volume are shown in data sets “b” in FIG. 11. The effects of increasing the leakage area up to 308 mm² are shown by data sets “c” through “e”. It can be seen that the influence of the rear volume dominates the speaker-to-ear characteristics until the leakage is very large. This is especially noticeable in the phase characteristics, where the gross disturbance exhibited by plot “a” gradually diminishes in magnitude and increases in frequency with increasing leakage.

Although the effects of this rear-volume resonance can be reduced somewhat by increasing the rear leakage to a very large value, in plot “e” they are still present at a frequency of 2 kHz, and the associated rear volume leakage area of 308 mm² represents a very large exposed area, from which outward sound emission occurs.

In short, the presence of a conventional rear volume that is large enough not to interfere with the effective compliance of the loudspeaker (and hence enable a good low-frequency performance) introduces gross phase artefacts which prevent useful noise-reduction. By venting the rear volume, the phase disturbance can be reduced, but not eliminated, and at the expense of significant outward sound emission.

In order to create a structure with the properties of an open-type rear volume, but where the outward emission can be spatially controlled, embodiments of the invention use a rear conduit structure as described in our WO 2005/051037, the disclosure of which is hereby incorporated by reference and relates to a system devised to provide an emission outlet at some distance from an electro-acoustic transducer, in which a conduit resonance is minimised (and moved to a higher frequency) by maximising the outlet area and minimising both the conduit volume and length, and arranging for an increasing cross-sectional area along its length. The said WO 2005/051037 further describes the use of integral Helmholtz resonators or quarter-wave stubs to eliminate or reduce any residual conduit resonance. Such resonators or stubs can be readily implemented using a miniature planar acoustic network of a kind disclosed in our UK patent application GB 0510438.5.

This arrangement still creates a degree of outward emission, but now it can be spatially controlled, and this enables the rear leakage to be merged, via suitable venting arrangements, with the outward emission from the inbuilt frontal volume leakage so as to undergo destructive interference, thereby substantially eliminating the overall outbound emission.

Regarding leakage/venting arrangements, the acoustic signals generated by the loudspeaker in the rear volume are the inverse (180° out of phase) of those in the frontal volume. Hence, by arranging for the outer aperture of the inbuilt frontal leakage conduit and the outlet of the rear volume conduit to be directly adjacent to one another, the outward emissions from both apertures cancel each other out.

With specific regard to the use of embodiments of the invention in association with an active ambient noise reduction system, the basic concepts of feedback and feed-forward noise reduction systems are well known in the art, and are described in more detail in our UK patent application GB 0606630.2. However some considerations of particular pertinence to the present invention are set out below.

The present invention is particularly valuable for application with the feed-forward method, in which the ambient acoustic noise that occurs around an individual who is listening to an ESD is detected by a microphone on, or inside, the ESD's housing. This signal is electronically inverted and added to the drive signal applied to the speaker of the ESD, so as to create an acoustic signal which, ideally, is equal in magnitude, but opposite in polarity, to the incoming ambient acoustic noise signal, adjacent to the headphone loudspeaker outlet port within the cavity between the ESD and the outer ear. Consequently, destructive wave interference occurs between the incoming acoustic noise and its inverse, generated via the speaker of the ESD, such that the ambient acoustic noise level perceived by the listener is reduced.

A fundamental requirement of such systems is that the frequency-dependent amplitude and phase characteristics of the generated acoustical cancellation signal must match those of the incoming ambient noise signal at the eardrum of the listener. Very tight tolerances are needed for even a modest amount of noise cancellation. If 65% cancellation (−9 dB) is to be achieved (residual noise signal=35%), then, assuming perfect phase matching, the amplitude of the cancellation signal must be matched to that of the noise signal within ±3 dB. Similarly, even if the amplitudes are perfectly matched, the relative phase of the signals must lie within ±20° (0.35 radian).

However, although the external ambient noise signal is the common source of both the noise signal at the ear and its synthesised cancellation counterpart, both of these signals are modified considerably and differently by their respective acoustical and electrical pathways to the eardrum. Provided that these differences are not too excessive, it is possible to introduce electronic signal-processing to compensate for the differences and re-align the amplitude and phase characteristics of the cancellation signal so as to be sufficiently similar to those of the noise signal.

These various primary signal pathways are depicted in FIG. 12. Each has a respective transfer function comprising both a frequency-dependent amplitude characteristic and an associated frequency-dependent phase characteristic. There are four of these primary transfer functions, as listed below.
1: Ambient-to-Ear (termed hereinafter “AE”)
This represents the acoustical leakage pathway by which external ambient noise signals reach the ear, and includes transmission around and through the ear-pad and headphone casing.
2: Ambient-to-Microphone(s) (termed hereinafter “AM”)
This represents the acousto-electric response of the external microphone (or microphones) as deployed in their operational mode, which includes local acoustical effects (for example, of the listener's head).
3: Speaker-to Ear or Driver-to-Ear (termed hereinafter “DE”)
This represents the electro-acoustical couple between the driver unit (a small, high-compliance loudspeaker) and the eardrum of the listener. This is strongly influenced by the nature of the acoustical load that it drives, a key feature of which is the acoustical leakage pathway (item 1, above) between the driver-to-ear cavity and the external ambient.
4: Electronic Amplification (termed hereinafter “A”)
This is the electrical transfer function of the amplifier. Although it is commonplace to provide an amplifier having a “flat” (i.e. relatively constant) amplitude characteristic as a function of frequency, it is usually necessary or convenient in practise to incorporate one or more AC coupling stages, and these behave as first-order low-cut (high-pass) filters. It is important to take account of this.

By inspection of FIG. 13, it is now possible to define the residual noise spectrum for a simple “invert and add” cancellation system, that is, one which does not use any additional signal processing. The ambient noise signal is defined here to be N (a function of frequency). The residual noise signal can be computed by vector subtraction of the noise cancellation signal from that noise signal which would be present at the ear with the cancellation system inactive, as follows:

Residual Noise=(N*AE)−(N*AM*A*DE) (2)

where the algebraic operators refer to vector operations, using complex notation and arithmetic to compute amplitude and phase spectra. Clearly, if the microphone and amplifier responses are ideally flat (i.e. both AM and A=1), then the residual noise at the ear after the cancellation process will be minimal if the AE and DE responses are similar (and it will be zero if they are exactly the same).

For the purposes of ambient feed-forward noise-cancellation, it is therefore essential to devise a headphone structure in which the AE and DE responses are very similar to each other.

On this basis, an open-back headphone system appears the best platform on which to base a feed-forward noise-reduction ESD. However, although this can yield very successful results in terms of noise-reduction effectiveness, there are some associated practical problems that are undesirable, as follows.
1. Feedback
The large frontal leakage through the foam pads (AE) requires that a large drive signal is fed to the loudspeaker in order to cancel the large incoming noise signal. The resultant acoustic signals can be so great that, when the headphones are adjusted or removed from the head, they can couple back to the external microphone(s) causing loud oscillation and “howl around” feedback.
2. Power Consumption
The large drive signal requirement, referenced above, requires significant power and makes significant demands on battery output, resulting in a much reduced battery life; a characteristic which is highly undesirable for mobile devices.
3. Headroom
A larger drive signal requires a greater drive voltage, and this can limit the maximum noise sound pressure level that the cancellation system can deal with, which can be a problem for ESDs when used on aircraft, for example.
4. Foam ear-pads
(a) The foam ear-pads suffer wear with time, compressing and degrading, thus causing their acoustical leakage (AE) properties to change considerably. This requires a significant change to the actual level of the noise-reduction signal; as do the following features.
(b) There is considerable variation in the acoustical leakage depending on how well—and whereabouts exactly—the pads are located on to the ears of the listener each time they are used. The leakage is unpredictable and thus often varies from one placement to the next.
(c) The leakage at the pad-to-ear interface is dependent on ear topography and size, and hence varies significantly between individuals.
(d) The leakage is dependent on the amount of pressure exerted by the headband, and therefore varies with head size and with use.
An increase in AE leakage will increase the incoming noise level, but, at the same time, will decrease the cancellation signal. Bearing in mind that that the two must be closely matched, to within 3 dB or better, it can be seen that noise-reduction effectiveness is sensitive even to small changes in acoustical leakage.

In view of this, it might be thought that the use of doughnut-type ear-pads would be better, in that they would form a more isolating seal. The problem with this approach is that it creates a resonant cavity between the ESD and the outer-ear. There remains a leakage pathway under the doughnuts, especially at low frequencies, but unfortunately this is a serial element to the incoming leakage (the AE path), whereas it represents a parallel load for the DE response. Changes in leakage, therefore, affect these functions in very different ways, and this is in direct conflict with the goal of making the two functions as similar to each other as possible.

Furthermore, the main acoustical leakage in such a system takes place underneath the doughnuts themselves, at their interface with the outer-ear where the skinning material cannot conform perfectly to the intricate contours of the pinna. Although this leakage is much smaller than that for foam ear-pads, typically having a leakage surface area of up to, say, 10 mm² (rather than several hundred mm² for foam pads), a consequence is that, in use, the variations in leakage from one placement on the head to the next, and from one person to another, are proportionately large (a change from 2 mm² to 6 mm² representing an increase to 300%), and the DE function is highly sensitive to small leakage variations when the leakage itself is small and tending to zero.

Another problem with the use of doughnut-type pads is that a small leakage represents, effectively, an almost closed acoustical system at the ear (the load impedance is almost a pure compliance), and this has a major effect on the phase response of the DE function, making ambient noise-reduction difficult, or even impossible, to achieve.

1-21. (canceled)

22. An in-ear type earphone, configured to fit into the outer ear of a wearer, comprising a speaker and a microphone,
wherein the speaker is positioned to direct sound into the ear of the wearer when the earphone is in the outer ear of the wearer, and the microphone is positioned to detect ambient noise when the earphone is in the outer ear of the wearer,
such that sound generated by the speaker arrives at the ear of the wearer with a frequency characteristic that is determined by a speaker-to-ear frequency response,
wherein the earphone is configured such that, when the earphone is in the outer ear of the wearer, a sound leakage channel is defined, said sound leakage channel providing a predetermined sound leakage such that variations in sound leakage due to a position of the earphone in the outer ear of the wearer have a small effect on the speaker-to-ear frequency response.

23. An earphone as claimed in claim 22, wherein the position of the speaker defines a frontal volume and a rear volume within the earphone.

24. An earphone as claimed in claim 23, wherein the sound leakage channel extends from the frontal volume of the earphone to the exterior.

25. An earphone as claimed in claim 22, wherein a frontal leakage impedance of the sound leakage channel depends on a length and cross-sectional area of the sound leakage channel.

26. An earphone as claimed in claim 25, wherein the frontal leakage impedance of the sound leakage channel further depends on an amount of damping in the sound leakage channel.

27. An earphone as claimed in claim 22, further comprising a rear conduit extending from the rear volume of the earphone to the exterior.

28. An earphone as claimed in claim 22, wherein the speaker-to-ear frequency response is flat within a range of about 4 dB in a frequency range from 80 Hz to 800 Hz.

29. A noise reduction system, comprising:
an earphone, comprising a speaker for generating sound in response to a received electrical signal;
a microphone, for detecting ambient noise and generating an ambient noise signal; and
a noise cancellation signal processing system, for receiving the ambient noise signal from the microphone and generating a noise cancellation signal for application to the speaker,
wherein the earphone defines an acoustic leakage channel by which ambient noise reaches an ear of a wearer of the earphone, said acoustic leakage channel having an ambient-to-ear transfer function, such that a seal, preventing inward or outward transmission of sound to or from the ear of the wearer is avoided.

30. A noise reduction system as claimed in claim 29, wherein the leakage provided by acoustic leakage channel is sufficiently large that disturbance of the ambient-to-ear transfer function is kept within tolerable limits.

31. A noise reduction system as claimed in claim 29, wherein the leakage provided by acoustic leakage channel is sufficiently large that variations of leakage past the earphone are small in relation to the leakage provided by the acoustic leakage channel.

32. A noise reduction system as claimed in claim 29, wherein the noise cancellation signal processing system applies a constant gain to the ambient noise signal in generating the noise cancellation signal.

33. A noise reduction system as claimed in claim 29, wherein the acoustic leakage channel provides a sound leakage path of predetermined dimensions

34. A noise reduction system as claimed in claim 29, wherein the earphone is configured such that it fits loosely into the outer ear of a wearer.

35. A noise reduction system, comprising:
an earphone, comprising a speaker for generating sound in response to a received electrical signal;
a microphone, for detecting ambient noise and generating an ambient noise signal; and
a noise cancellation signal processing system, for receiving the ambient noise signal from the microphone and generating a noise cancellation signal for application to the speaker,
wherein an acoustical leakage pathway by which ambient noise reaches an ear of a wearer of the earphone has an ambient-to-ear transfer function,
wherein an electro-acoustic coupling between the speaker and the ear of the wearer of the earphone has a speaker-to-ear transfer function, and
wherein the earphone defines an acoustic leakage channel, such that the ambient-to-ear transfer function and the speaker-to-ear transfer function are matched.

36. A noise reduction system as claimed in claim 35, wherein the speaker-to-ear frequency response is flat within a range of about 4 dB in a frequency range from 80 Hz to 800 Hz.

37. A noise reduction system as claimed in claim 35, wherein the earphone is configured such that it fits loosely into the outer ear of a wearer.

38. A noise reduction system as claimed in claim 35, wherein the noise cancellation signal processing system applies a constant gain to the ambient noise signal in generating the noise cancellation signal.

39. A noise reduction system as claimed in claim 35, wherein the position of the speaker defines a frontal volume and a rear volume within the earphone, and wherein the sound leakage channel extends from the frontal volume of the earphone to the exterior.

40. An in-ear type earphone, configured to fit in the outer ear of a wearer, comprising:
a speaker, and
a microphone for detecting ambient noise,
wherein the earphone is further configured such that, in use, a sound leakage channel is defined that provides a predetermined sound leakage pathway between the outer ear and the ambient.

41. An in-ear type earphone comprising:
a speaker, and
a microphone for detecting ambient noise,
wherein the earphone is configured such that, in use, a sound leakage channel is defined that provides a predetermined sound leakage pathway such that variations in sound leakage due to a position of the earphone in the outer ear of the wearer are negligible, relative to the sound leakage of the sound leakage channel.
